(19) United States
(12) Patent Application Publication
(10) Pub. No.: US 2015/0107437 A1
(43) Pub. Date: Apr. 23, 2015

(54) CAPO FOR FRETTED STRINGED INSTRUMENT AND METHOD OF USING SAME

(71) Applicant: James L. Cannon, Murrayville, GA (US)

(72) Inventor: James L. Cannon, Murrayville, GA (US)

(21) Appl. No.: 14/060,787

(22) Filed: Oct. 23, 2013

(51) Int. Cl. G10D 3/04

(52) U.S. Cl. CPC G10D 3/043
USPC 84/318

(57) ABSTRACT

The invention comprises a capo for fretted stringed instruments. The capo comprises a string pressure plate sized and shaped to cover two adjacent frets and simultaneously press strings of the fretted stringed instrument into contact with the two adjacent frets of the fretted stringed instrument. The capo also comprises an attachment mechanism that attached the string pressure plate to a fretboard of the fretted stringed instrument. A method of using the capo is also disclosed.

### FIELD OF THE INVENTION

The present invention generally relates to a capo for fretted stringed instruments. More particularly, this invention relates to a guitar capo. Specifically, the present invention relates to a capo for fretted stringed instruments that does not cause a significant change in pitch when attached to a fretted stringed instrument. Furthermore, the present invention relates to a capo that does not interfere with the fingering of chord formations on the fretboard of a fretted stringed instrument. A method of using a capo is also disclosed.

### BACKGROUND OF THE INVENTION

Capos (aka capotasto) are known for use with fretted stringed instruments, particularly guitars. A capo is a device that is used on the neck of a fretted stringed instrument to shorten the playable length of the strings thereby changing the pitch of the strings. A capo is typically used to raise the pitch of a fretted instrument so that the player can play the instrument in a key different from its original tuning

There are numerous styles of capos, but most commercial capos consist of a rubber-covered bar that holds down the strings of the instrument and is clamped to the instrument by one of a number of mechanisms. One of the more common modern capo styles is the spring-clamp “trigger-style” capo. The most common form of this type of capo has two bars: a rubber-covered bar to bane the strings, and another that presses against the back of the neck of the instrument to hold the first bar to the strings (this second bar is commonly curved or shaped to match the contour of the back of the instrument neck). The two bars are pivotably attached at one end and a spring presses the bars together. The following are illustrative of different styles of capos: U.S. Patent Application Publication Nos. 2013/0192442; U.S. Pat. Nos. 8,101,839; 8,093,476; 7,973,227; 7,956,263; and 7,939,736 (the disclosures of which are all incorporated herein by reference).

One disadvantage of all prior art capos is that they depress the strings between adjacent frets. This changes the pitch of the strings. If a fretted stringed instrument is used with other tuned instruments, the instrument using the capo will play sharp relative to the other tuned instruments.

It would therefore be desirable to provide a capo for use with fretted stringed instruments that does not cause the instrument to play sharp.

### SUMMARY OF THE INVENTION

The present invention satisfies the foregoing needs by providing a capo for use with fretted stringed instruments, especially guitars. Accordingly, the present invention comprises a capo. The capo comprises a string pressure plate sized and shaped to cover two adjacent frets and simultaneously press strings of the stringed instrument into contact with the two adjacent frets of the stringed instrument. The capo also comprises an attachment mechanism that attached the string pressure plate to a fretboard of the stringed instrument.

In another disclosed embodiment, the present invention comprises a method of using a capo. The method comprises attaching a string pressure plate to a neck of a stringed instrument, wherein the string pressure plate is sized and shaped such that the string pressure plate covers two adjacent frets and presses the strings into contact with two adjacent frets of the stringed instrument.

In another disclosed embodiment, the present invention comprises a method of using a capo on a guitar. The method comprises attaching a string pressure plate to a neck of the guitar, wherein the string pressure plate is sized and shaped such that the string pressure plate covers two adjacent frets and presses the strings into contact with the two adjacent frets of the stringed instrument and wherein the string pressure plate does not depress the strings between the adjacent frets

Accordingly, it is an object of the present invention to provide an improved capo for a fretted stringed instrument, such as a guitar.

Another object of the present invention is to provide a capo that does not cause the fretted stringed instrument with which it is used to play sharp.

A further object of the present invention is to provide a capo that does not depress the strings between adjacent frets.

Another object of the present invention is to provide a capo that does not interfere with fingering of the chord formations.

Yet another object of the present invention is to provide a capo that is attractive and is easy to use.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a perspective view of a disclosed embodiment of a capo for use with a fretted stringed instrument in accordance with the present invention.

FIG. 2 is a top plan view of the pressure plate shown in FIG. 1.

FIG. 3 is a side view of the pressure plate shown in FIG. 1.

FIG. 4 is a top plan view of the capo attachment mechanism shown in FIG. 1.

FIG. 5 is a side view of the capo attachment mechanism shown in FIG. 1.

FIG. 6 is a perspective view of the capo shown in FIG. 1 attached to the neck of a guitar.

FIG. 7 is a partial cross-sectional view taken along the line 7-7 of the capo and guitar neck shown in FIG. 6.

### DETAILED DESCRIPTION OF THE DISCLOSED EMBODIMENTS

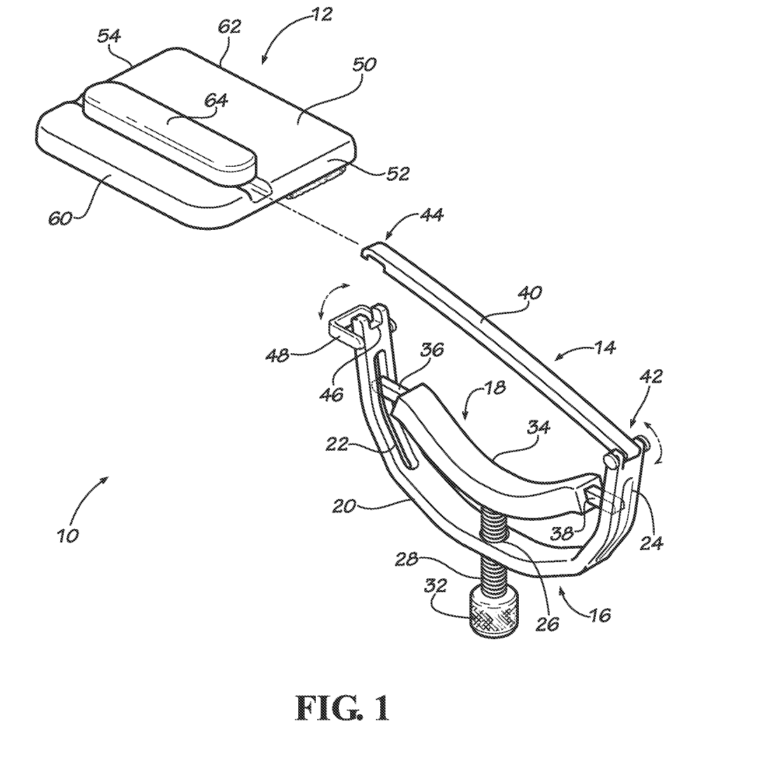

Referring now to the drawing in which like numbers indicate like elements throughout the several views, there is shown in FIG. 1 a disclosed embodiment of a capo 10 in accordance with the present invention. The capo 10 comprises a pressure plate 12 and an attachment mechanism 14 for attaching the capo to the neck of a fretted stringed instrument, especially a guitar. The attachment mechanism is shown in detail in FIGS. 1, 4 and 5. The attachment mechanism is similar to the capo disclosed in U.S. Pat. No. 7,973,227 (the disclosure of which is incorporated herein by reference). There are many different attachment mechanisms that will work with the present invention. The following illustrate several prior art capo attachment mechanisms that can be used with the present invention: U.S. Patent Application Publication Nos. 2013/0192442; U.S. Pat. Nos. 8,101,839; 8,093,476; 7,956,263; and 7,939,736 (the disclosures of which are all incorporated herein by reference).

The attachment mechanism 14 includes a yoke assembly 16 and a slide assembly 18. The yoke assembly includes a U-shaped yoke 20. The yoke 20 defines a first elongate slot 22 and a second elongate slot 24. The base of the yoke 20 defines a hole 26 which include a plurality of female threads (not shown). A screw 28, which includes a plurality of male threads 30 and a knurled knob 32, is received in the hole 26 such that the male threads mate with the female threads (not shown) in the hole.

The slide assembly 18 includes a curved saddle member 34. The end (not shown) of the screw 28 opposite the knurled knob 32 is rotatably attached to the saddle member 34. Each end of the saddle member 34 includes a pin 36, 38 that extends outwardly from the saddle member. The pins 36, 38 are received in the slots 22, 24, respectively. The pins 36, 38 and slots 22, 24 keep the saddle member 34 from rotating when the screw 28 is rotated. It will be appreciated that when the screw 28 is rotated, it will move the saddle member 34 up and down depending on the direction of rotation of the screw.

The capo 10 also includes a latch bar 40. One end 42 of the latch bar 40 is pivotably attached to one arm of the yoke 20. The other end 44 of the latch bar 40 fits into a notch 46 in the other arm of the yoke 20. Pivotably attached to the same arm of the yoke 20 is a U-shaped latch member 48. When the end 44 of the latch bar 40 is received in the notch 46, the U-shaped latch member 48 can be pivoted over the top of the latch bar (as shown in FIG. 5) thereby locking the latch bar to the yoke 20. When the U-shaped latch member 48 is pivoted away from the latch bar 40 (as shown in FIG. 1), the latch bar can be moved away from the notch 46 in the yoke 20, thereby allowing the attachment mechanism 14 to be placed on the neck of a stringed instrument and then locked in position.

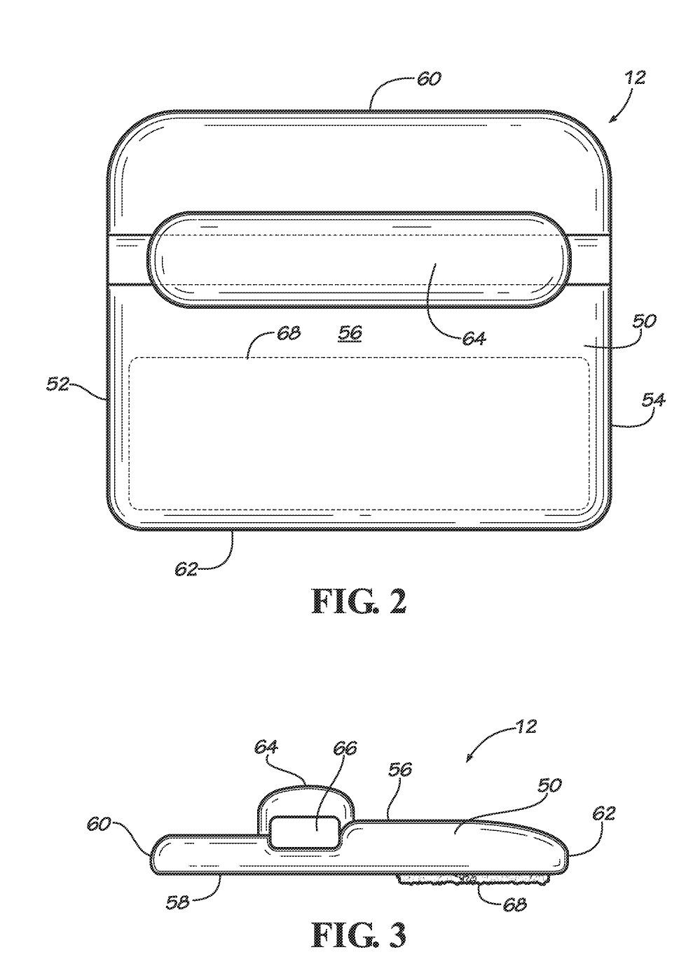

The pressure plate 12 comprises a plate member 50 made from a rigid material including, but not limited to, wood, plastic, metal or composite materials. The plate member 50 has a first edge 52 and an opposite second edge 54 (FIG. 2). The plate member also has an upper surface 56 and a lower surface 58. The plate member 50 further has a front edge 60 and a rear edge 62. The lower surface 58 of the plate member 50 has a concave curve from the first edge 52 to the second edge 54. The radius of this concave curvature is selected so that it matches the radius of convex curvature of the guitar neck fretboard to which it is to be attached. As a result, when the lower surface 58 of the plate member 50 is placed in contact with the fret board of a stringed instrument, the lower surface will contact the frets of the fretboard continuously from the first edge 52 to the second edge 54 and without gaps between the fret and the lower surface.

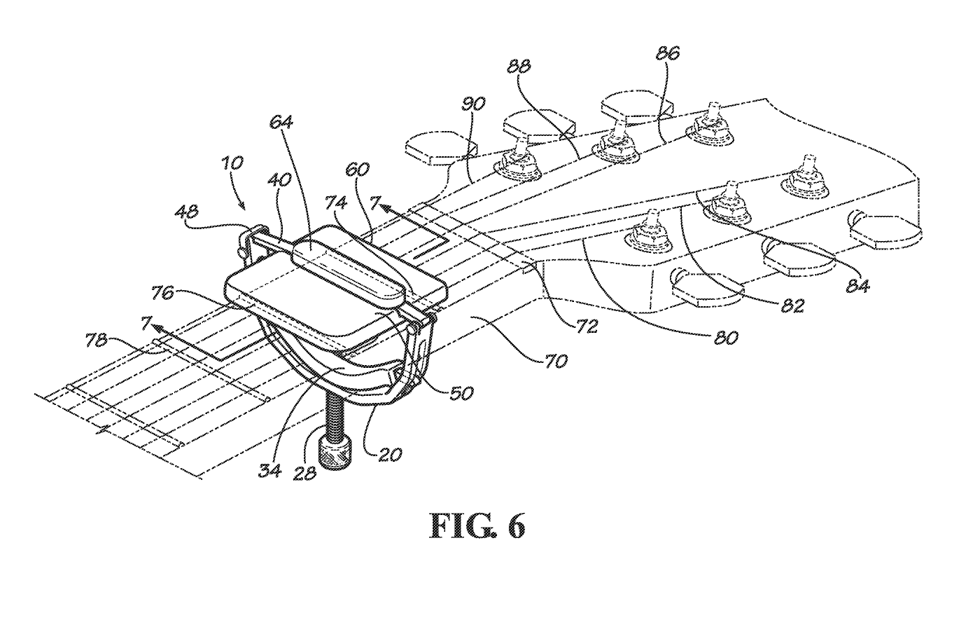

Formed on the upper surface 56 of the plate member 50 is a rib 64. The rib 64 and the plate member 50 define a channel 66. The channel 66 is sized and shaped so that the latch bar 40 can be received within the channel and such that the pressure plate 12 is pivotably mounted on the latch bar between the arms of the yoke 20 as shown in FIG. 6. The pressure plate 12 is mounted on the latch bar 40 such that the lower surface 58 of the plate member 50 faces toward the saddle member 34. The lower surface 58 of the plate member 50 includes a filler member 68. The filler member 68 is attached to the lower surface 58 adjacent the rear edge 62 and extends substantially from the first edge 52 to the second edge 54 and from the rear edge to the rib 64 or near the rib (see FIGS. 2 and 3). The filler member 68 is made from a resilient material including, but not limited to, plastic, rubber, plastic foam, rubber foam or a fabric, such as a felt. A preferred material for the filler member 68 is the loop portion of a hook and loop fastener, such as Velcro®. The filler member 68 is attached to the lower surface 58 of the plate member 50 with an adhesive. Although the lower surface 58 of the plate member 50 is concave, it may not match the curvature of the fretboard of every guitar. The filler member 68 is designed to accommodate the fretboard of fretted stringed instruments that do not match the radius of curvature of the lower surface 58 of the capo 10 exactly.

Use of the capo 10 in accordance with the present invention will now be considered. As seen in FIG. 6 there is a guitar neck 70 which include a nut 72, a first fret 74, a second fret 76 and a third fret 78. The guitar neck 70 also includes six strings 80, 82, 84, 86, 88, 90.

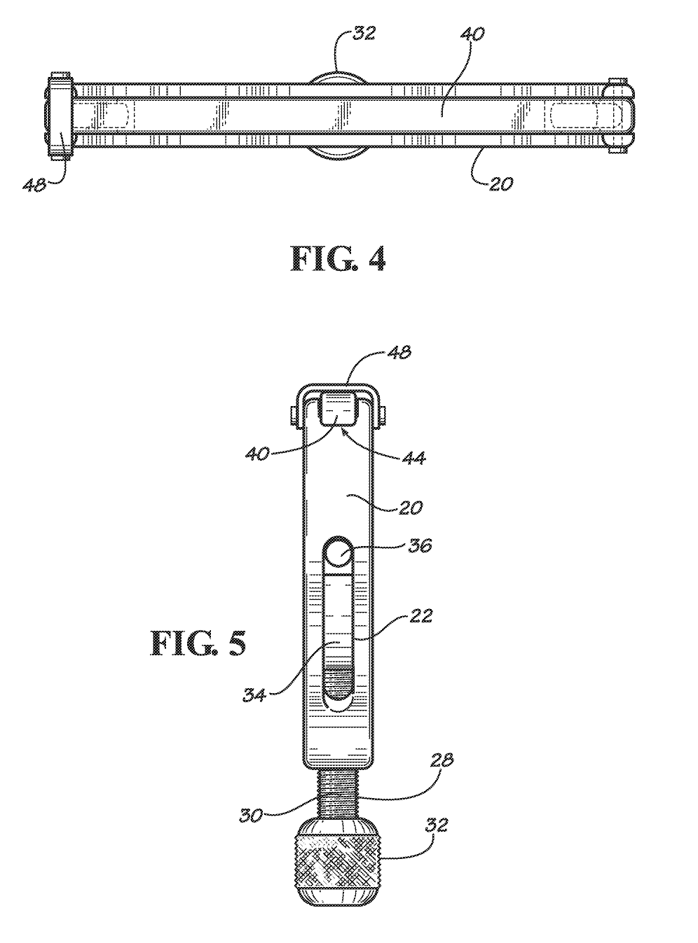

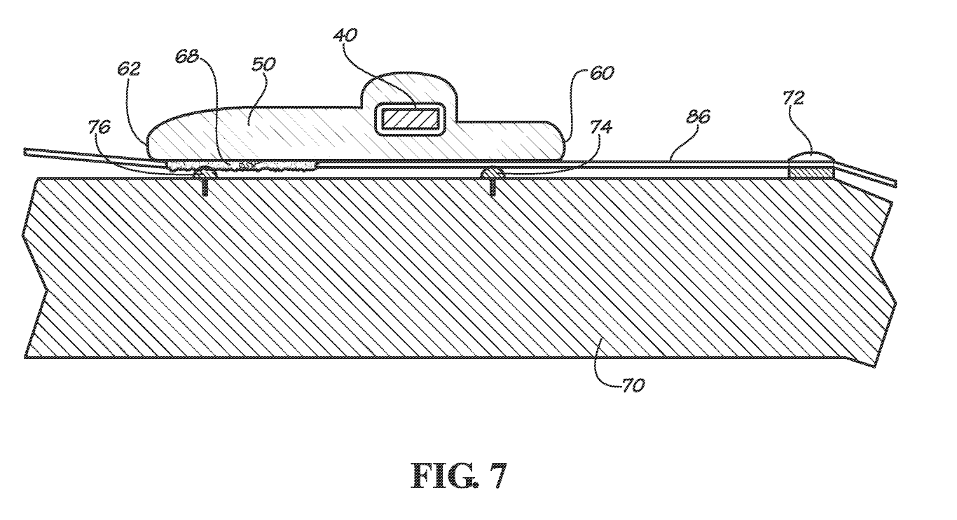

The capo 10 is placed on the guitar neck 70 by first releasing the U-shaped latch member 48 and pivot the latch bar 40 away from the notch 46 so that the guitar neck can be positioned on the saddle member 34 and between the arms of the yoke 20. The latch bar 40 is then pivoted back into the closed position with the end 44 received in the notch 46 and the U-shaped latch member 48 is pivoted so that is captures the end of the latch bar (as shown in FIGS. 4 and 5). The screw 32 is then rotated so as to raise the saddle member 34 toward the back of the guitar neck 70. The screw 32 is rotated further so that the strings 80-90 are captured between the lower surface 58 of the plate member 50 and one of the frets 74-78. The pressure plate 12 is positioned on the guitar neck 70 and the pressure plate is sized and shaped such that when the capo is attached to the guitar neck the lower surface 58 of the plate member 50 contacts two adjacent frets, such as the first fret 74 and the second fret 76 (as shown in FIGS. 6 and 7). It is an essential feature of the present invention that the bottom surface 58 of the plate member 50 contacts two adjacent frets rather that being positioned between two adjacent frets and does not depress the strings 80-90 between the adjacent frets, which is how prior art capos function. By contacting two adjacent frets, such as the first fret 74 and the second fret 76, the strings 80-90 are not stretched by depressing them between adjacent frets, which results by the use of prior art capos (FIG. 7). Instead, the strings 80-90 are merely pressed into contact with the adjacent frets, such as the first fret 74 and the second fret 76. As such, the capo 10 of the present invention rides on top of the adjacent frets instead of sinking between adjacent frets and stretching the strings, as practiced by the prior art. By riding on top of the adjacent frets, the capo of the present invention does not cause the strings 80-90 to go slightly sharp in tone. This is a significant advantage over the prior art.

When the capo 10 is positioned on the guitar neck 70, as shown in FIGS. 6 and 7, such that the filler member 68 is positioned over the second fret 76 and contacts the strings 80-90 while the other portion of the capo is positioned over the first fret 74. The filler member 68 prevents the strings 80-90 from buzzing or vibrating due to minor variations in the contour of the fretboard which otherwise might result from the strings not being pressed into completely contact with the second fret 76. The filler member 68 also presses the strings 80-90 into contact with the second fret 76 even though the fretboard of the guitar neck 70 may have a slightly different radius of curvature.

If it is desired to reposition the capo 10 on the guitar neck 70, the screw 32 is rotated so that the saddle member 34 is moved downward (i.e.; away from the latch bar 40). The pressure plate 12 can then be slid to a different position, for example so that the lower surface 58 of the plate member 50 is positioned over two different adjacent frets, such as the second fret 76 and the third fret 78. The screw 28 is then rotated so that the saddle member 34 is moved upwardly (i.e.; toward the latch bar 40) so that the pressure plate 12 is pushed into firm contact with the frets 76-78.

To remove the capo 10 from the guitar neck 70, the screw 32 is rotated so that the saddle member 34 is moved downward (i.e.; away from the latch bar 40). The U-shaped latch member 48 is rotated off the end 44 of the latch bar 40 to the position shown in FIG. 1) and the latch bar is pivoted away from the notch 46 in the yoke 20. The neck 70 is then removed from between the opposite arms of the yoke 20.

In a preferred embodiment, the thickness of the plate member 50 between the rib 64 and the front edge 60 is thinner than the thickness of the plate member between the rib and the rear edge 62. This provides the capo 10 with a profile that is minimized so as not to interfere with fingering of the chord formations.

The upper surface 56 of the plate member 50 also provides a surface that can be decorated or personalized. For example, the plate member 50 can be made from an attractive wood, such as Rosewood, Ebony, Walnut, Maple or the like, and nicely finished to match the material from which the fretboard or the body of the stringed instrument is made. The upper surface 56 of the plate member 50 can include a design of monogram, such as by inlaying with mother of pearly, a decal simulating inlay or another attractive material. This provides a capo 10 that is more attractive than prior art capos.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A capo for use with a fretted stringed instrument, the capo comprising:
a string pressure plate sized and shaped to cover two adjacent frets and simultaneously press strings of the fretted stringed instrument into contact with the two adjacent frets of the fretted stringed instrument; and
an attachment mechanism that attaches the string pressure plate to a fretboard of the fretted stringed instrument.

2. The capo of claim 1, wherein the string pressure plate is sized and shaped so that the string pressure plate does not depress the strings of the stringed instrument between the two adjacent frets.

3. The capo of claim 1, wherein the pressure plate has a primary surface that contacts the strings of the fretted stringed instrument and wherein the primary surface is concave.

4. The capo of claim 1 further comprising a filler member attached to the primary surface.

5. The capo of claim 1, wherein the pressure plate is made from wood, plastic, metal or composite materials.

6. The capo of claim 1, wherein the pressure plate is made from wood.

7. A method of using a capo comprising attaching a string pressure plate to a neck of a fretted stringed instrument, wherein the string pressure plate is sized and shaped such that the string pressure plate covers two adjacent frets and presses the strings into contact with two adjacent frets of the fretted stringed instrument.

8. The method of claim 7, wherein the pressure plate does not depress the strings of the fretted stringed instrument between the two adjacent frets.

9. The method of claim 7, wherein the capo has a profile such that it does not interfere with fingering of chord formations on the fretboard of the fretted stringed instrument.

10. A method of using a capo on a guitar comprising attaching a string pressure plate to a neck of the guitar, wherein the string pressure plate is sized and shaped such that the string pressure plate covers two adjacent frets and presses the strings into contact with the two adjacent frets of the guitar and wherein the string pressure plate does not depress the strings between the adjacent frets.

11. The method of claim 10, wherein the capo has a profile such that it does not interfere with fingering of chord formations on the fretboard of the guitar.
